(19) United States
(12) Patent Application Publication
(10) Pub. No.: US 2017/0258039 A1
(43) Pub. Date: Sep. 14, 2017

(54) SENSOR ACTIVATED DOG WATERING STATION

(71) Applicant: Craig Lauterbach, Flemington, NJ (US)

(72) Inventor: Craig Lauterbach, Flemington, NJ (US)

(21) Appl. No.: 15/064,524

(22) Filed: Mar. 8, 2016

(51) Int. Cl. A01K 7/06; A01K 7/00

(52) U.S. Cl. CPC A01K 7/06; A01K 7/005

(57) ABSTRACT

An apparatus provides a watering station dispensing clean drinking water for dogs and other animals. The water is dispensed once the apparatus detects the presence of the animal. A solenoid valve regulates water flow in accordance with signals from the sensor. The water is fed to one or more water outlets either along a surface of the bowl or elsewhere along the housing of the watering station. The water is received from an incoming water supply line, which may be connected to a fresh water line within the dog owner's house or other building. The watering station may be installed in the owner's bathroom, laundry room, kitchen, outside, etc. Any water not consumed flows by gravity down a drain and can be disposed of through a wastewater line. This effectively eliminates standing water in the bowl. Various sizes of the watering station can accommodate different sized pets or other animals.

### BACKGROUND OF THE INVENTION

Field of the Invention

The present invention relates generally to a point of use watering fountain that provides clean, fresh water to dogs and other pets, as well as other kinds of animals.

Description of Related Art

As part of the care and feeding of their pets, pet owners will often leave a bowl of water out for the animals to drink from. This may require the pet owner to occasionally check to make sure there is sufficient water in the bowl. Also, food particles, hair and other objects may fall into the bowl, potentially contaminating the water.

While it may be possible to recirculate or filter the water, this may not provide an optimum water supply to the pet. Furthermore, when standing water is maintained in the bowl or held in a reservoir for later use, there is a possibility that the bowl gets knocked over or the water will otherwise be spilled. This can cause a mess and damage the floor.

### SUMMARY OF THE INVENTION

In order to address these issues and potential problems, a watering station is provided that avoids standing water and supplies fresh water when a dog or other pet comes to the watering station.

According to one aspect, using existing battery powered infrared sensor technology, available from many manufacturers, fresh water may flow into a bowl or other receptacle once the animal approaches or enters the watering station so that its head is beneath the sensor. In accordance with another aspect, saliva and unused water will immediately drain through a fitting in the bottom of the bowl. Thus, there will be no standing water to attract insects and no water being spilled onto the floor, which are certain situations aspects of the invention are designed to address.

In case of sensor failure or a clog, the watering station will have a built in overflow. In one example, the overflow is positioned on the side of the bowl below the incoming water, creating the necessary air gap to avoid the possibility of contamination of the potable water system.

In accordance with a further aspect of the invention, the watering station may be manufactured in various sizes to accommodate all canine breeds, and felines as well. Mounting brackets may be employed to secure the watering station to a wall or other support surface at a height appropriate for the animal(s) that will use the watering station. Cats will use their curiosity to quickly learn how the fountain watering station works and most dogs will understand its use after being shown just once.

Features of the inventive technology are described in detail below.

In accordance with aspects of the technology, a watering station for use by household pets and other animals is provided. The watering station includes a receptacle adapted to receive at least a portion of a head of an animal during drinking of potable water from the watering station, as well as a bowl element adjacent to the receptacle and configured to receive excess water not consumed by the animal. A sensor is configured to detect a presence of the animal. An incoming water supply line is adapted to provide potable water to the watering station. A water supply regulator is operatively coupled to the sensor and the incoming water supply line. One or more water distribution lines are coupled to the incoming water supply line. The one or more water distribution lines have corresponding outlets adjacent to either the receptacle or the bowl element. A drainage element is disposed along a base region of the bowl element. The water supply regulator is configured to cause the incoming water supply line to dispense the potable water through the one or more water distribution lines in response to a signal from the sensor upon detection of the presence of the animal, and to cease dispensing the potable water upon cessation of the signal from the sensor. The drainage element is configured to remove unconsumed water from the bowl element such that substantially no standing water remains in a bottom region of the bowl element when the water supply regulator has ceased dispensing the potable water.

In one example, the drainage element includes a drain disposed along the bottom region of the bowl element and an outlet operatively coupled to the drain and configured for coupling to a wastewater pipe to evacuate the excess water from the watering station. Here, the drainage element may include an overflow receptacle disposed along a portion of the bowl element adjacent to the receptacle and operatively coupled to the outlet.

In another example, the water supply regulator comprises a solenoid device.

In one scenario, the watering station also includes a mounting bracket system configured to adjustably affix the watering station along a wall. Here, the mounting bracket system desirably includes at least two pairs of bracket elements, each pair having an outer bracket element and an inner bracket element. In one case, each outer bracket element includes two or more angled tabs arranged along a first wall of the outer bracket element.

Each inner bracket element may include slots corresponding to the two or more angled tabs of a respective outer bracket element, where the slots have a size and are arranged at a complementary position to receive a given one of the angled tabs. Preferably, corresponding ones of the outer and inner bracket elements form a U shape when arranged together, the U shape configured to envelope an edge of the wall to adjustably affix the watering station to the wall. The one or more fastener elements of the inner bracket elements can be used to pinch the outer and inner bracket elements together securely along the wall's edge. The mounting bracket system may include at least a pair of outer bracket elements configured to adjustably secure the watering station to stud members along the wall.

In accordance with another example, the incoming water supply line and the drainage element each include flexible connections to enable height adjustment of the watering station along a wall. In a further example, the watering station also includes a shut off valve operatively coupled to the incoming water supply line. In yet another example, the watering station further comprises a power receptacle electrically coupled to the water supply regulator. Here, the power receptacle may comprise a battery box configured to store one or more batteries therein. The batteries may be replaceable and/or rechargeable. The power receptacle may include an outer cover having a nameplate thereon. In a further example, a height of the bowl element is adjustable to accommodate animals of different sizes.

In accordance with other aspects of the technology, a mounting bracket system is provided for affixing an animal watering station to a wall structure. The mounting bracket system comprises at least two pairs of bracket elements, each pair having an outer bracket element and an inner bracket element. Each outer bracket element includes two or more angled tabs arranged along a first wall of the outer bracket element. The outer bracket elements are configured for adjustable placement along a surface of the animal watering station. Each inner bracket element includes two or more receptacles each adapted to receive corresponding ones of the angled tabs of the outer bracket elements.

In one example, each receptacle comprises a slot. Each slot has a size and is arranged at a complementary position to receive a given one of the angled tabs. In another example, corresponding ones of the outer and inner bracket elements form a U shape when arranged together. The U shape is configured to envelope an edge of the wall structure to adjustably affix the watering station to the wall structure.

### BRIEF DESCRIPTION OF THE DRAWINGS

FIGS. 1A-C illustrate an example of a pet watering station in accordance with aspects of the invention.

FIGS. 2A-C illustrate another exemplary pet watering station in accordance with aspects of the invention.

FIGS. 3A-C illustrate a further example of a pet watering station in accordance with aspects of the invention.

FIGS. 4A-F illustrate an example mounting bracket system for use in conjunction with the pet watering stations of FIGS. 1-3.

### DETAILED DESCRIPTION

The foregoing aspects, features and advantages of the disclosed technology will be further appreciated when considered with reference to the following description of exemplary embodiments and accompanying drawings. In describing the exemplary embodiments of the invention illustrated in the appended drawings, specific terminology will be used for the sake of clarity. However, the invention is not intended to be limited to the specific terms used. Also, similar features in different drawings may be referenced using similar element numbers. Certain features are shown in dashed or “broken” lines to indicate they are below or otherwise covered by a different element.

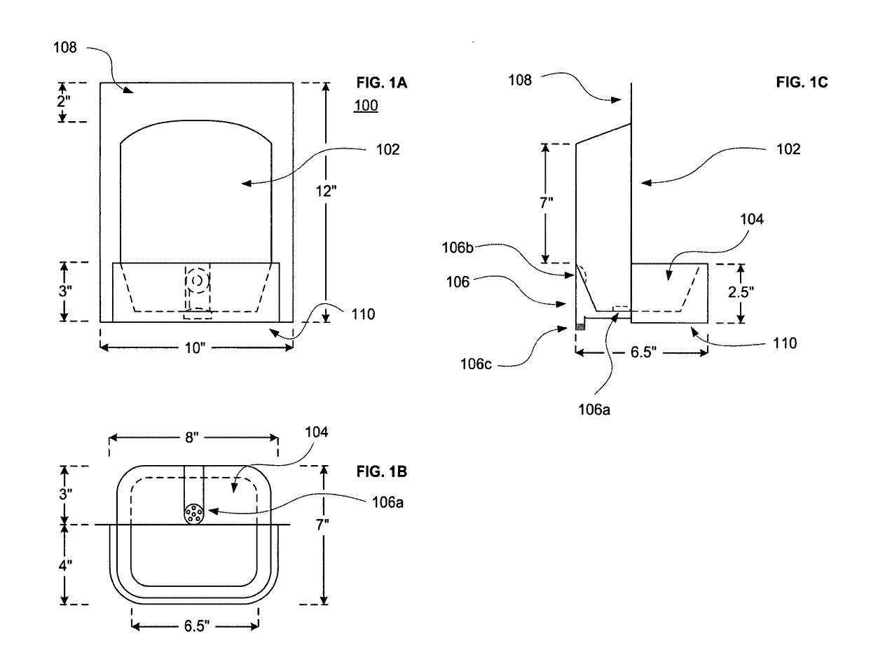

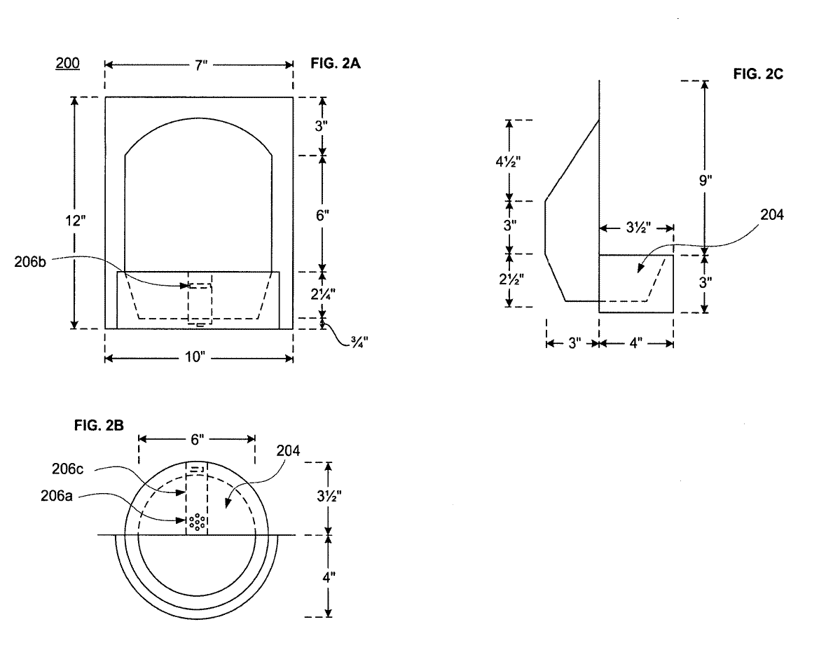

FIGS. 1A-C illustrate an exemplary watering station 100 in accordance with aspects of the invention. This example shows one variation of the overall housing of the watering station, while omitting certain plumbing and electrical components for clarity. While dimensions are indicated, they are merely representative of one possible sizing. The dimensions may vary depending on the size of the animal. For instance, the dimensions indicated in FIGS. 1A-C may be appropriate for a medium-sized dog breed such as a Labrador Retriever. Smaller dimensions would be more appropriate for smaller breeds, such as Pugs and Chihuahuas. And larger dimensions may be needed for breeds such as a Newfoundland or a Great Dane. As noted above, other types of pets such as cats may also use the watering station, and the dimensions may be varied in according with the size of those animals. Watering stations as described herein may also accommodate barnyard animals and other types of domesticated or undomesticated animals. In the discussion below, references will be made to dogs in the examples but it should be understood that the technology is not limited to such animals.

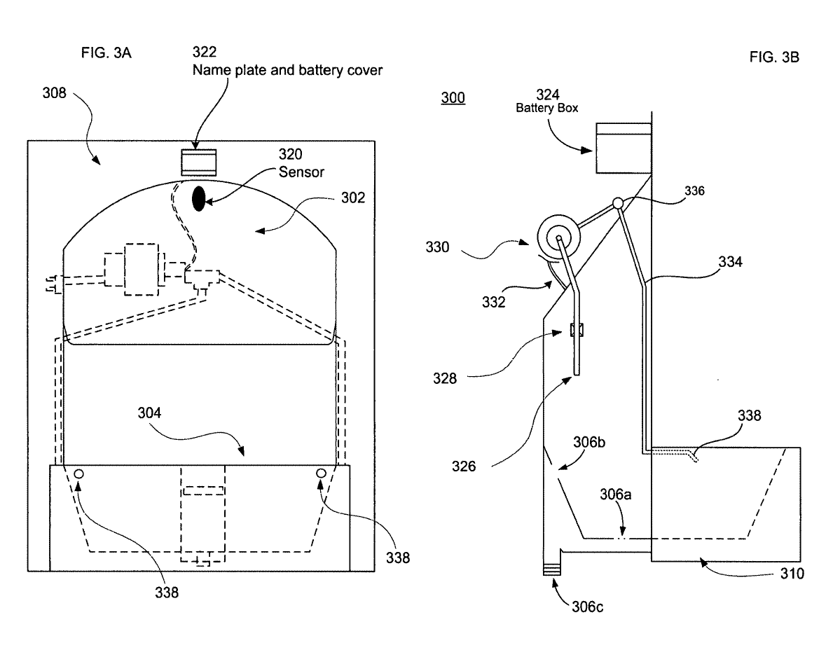

The watering station 100 includes a receptacle area 102 for the dog to insert its head to drink the water. A bowl element 104 is disposed at the base of the watering station 100. As shown, the bowl element 104 is generally rectangular in shape, although other shapes and configurations may be employed (see, e.g., FIGS. 2A-C).

As noted above, there is effectively no standing water in the watering station. Water that is not consumed by the dog is received by the bowl element and is removed via drainage element 106. The drainage element may include a drain 106a, an overflow 106b and an outlet 106c.

Also shown in FIGS. 1A and 1C is surface 108. In one embodiment, the watering station 100 is installed in the pet owner's house, for instance in a kitchen, bathroom, laundry room or basement near an existing potable water supply line. The watering station may be mounted along a wall such that the surface 108 is flush with adjacent parts of the wall. Here, base 110 of the watering station 100 may be flush with the floor. Alternatively, the base 110 may be elevated above the floor, for instance to accommodate very large dog breeds or to prevent the dog from ingesting air as it drinks the water. In this case, one or more support elements (not shown) may be placed along a front area of the bowl 104 for support.

In accordance with certain aspects, installation of the watering station may be in an area that provides the animal unfettered access. The installation height should be in accordance with the size of the animal. Preferably, a sizing chart may be provided for the pet owner or installer to use as a reference guide. The chart can also consider multiple pet households to accommodate different sized animals. For instance, the chart could indicate that when animals of widely varying sizes (e.g., Chihuahuas and Newfoundlands) are expected to use the watering station, the watering station may be installed at a height accessible by each type of animal.

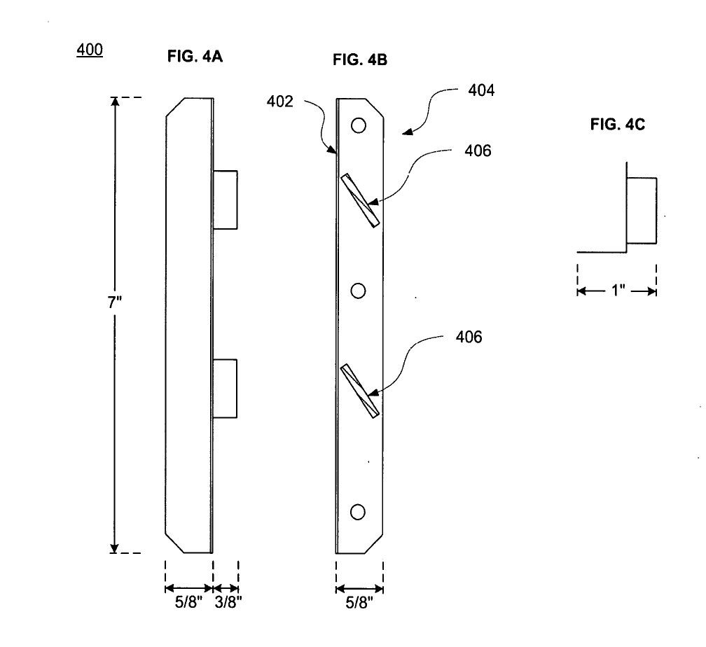

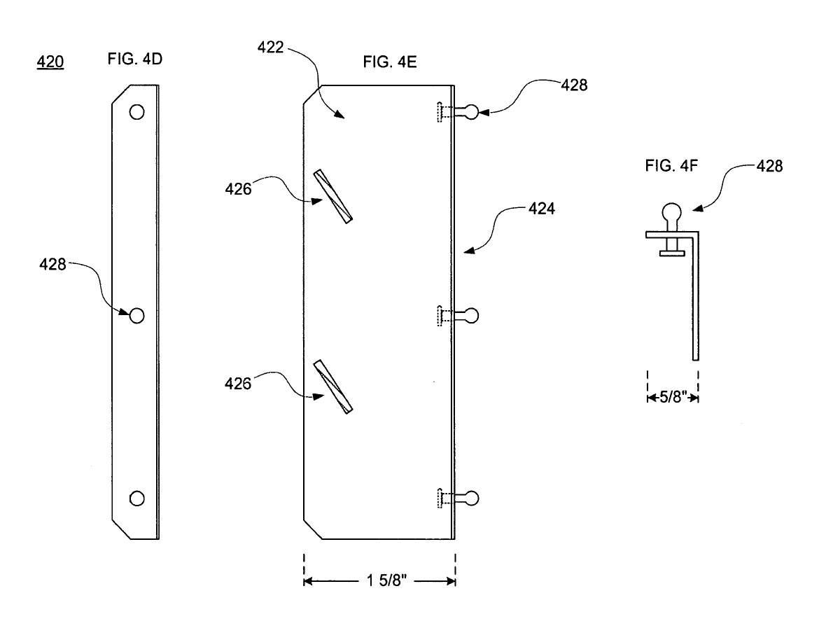

An adjustable height unit would be benefit homeowners that change breed or to accommodate the growth of a puppy. Thus, in one alternative, the watering station 100 may be height adjustable. This may be done using a mounting bracket system with mounting points to accommodate different heights. An example of this is shown in FIGS. 4A-F, which is discussed in detail below.

As noted above, the watering station may be installed in a bathroom, laundry room, or kitchen. The installation may be done as part of new construction or as a retrofit. Preferably, the unit should be installed as close to an existing source of plumbing as possible to simplify the connections and reduce installation and maintenance costs. By way of example only, potable water and waste water connections may be flexible, allowing for easy access to the components that may require future repair or replacement. The flexible connections are also beneficial when adjustably mounting the watering station. Depending on the location and specific implementation, it may be recommended that installation be performed by a licensed plumbing contractor so that all local plumbing codes are considered for a complete and successful installation.

FIGS. 2A-C illustrate another exemplary watering station 200 in accordance with aspects of the invention. As in FIGS. 1A-C, this example shows a variation of the overall housing while omitting certain plumbing and electrical components for clarity. In contrast to the generally rectangular shaped bowl 104 in the prior embodiment, the bowl 204 is shown as a circular bowl in this embodiment. The drainage element in this embodiment includes a drain 206a, an overflow 206b and an outlet 206c.

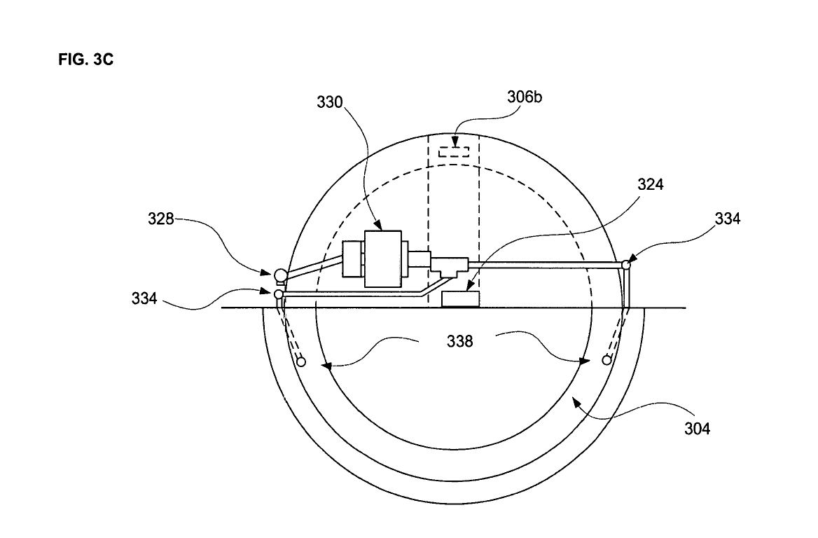

FIGS. 3A-C illustrate certain details of a watering station 300 in accordance with aspects of the invention. In particular, these figures illustrate a watering station including plumbing and electrical components. Elements identified in FIGS. 1A-C and 2A-C and described above are also illustrated in FIGS. 3A-C; however, for the sake of brevity those descriptions are not repeated below. And as discussed in the examples above, watering station 300 may have a rectangular, circular or other shape for the bowl element.

As shown in FIG. 3A, the watering station 300 desirably includes a sensor 320 to identify when the dog has approached for a drink of water. The sensor may be an infrared sensor or motion detector, although other conventional sensing elements could be employed. The sensor 320 may be disposed along a surface of receptacle area 302. Alternatively, the sensor 320 may be disposed along surface 308 or elsewhere on the watering station 300. In another example, the sensor 320 may be disposed along a portion of a wall adjacent or near the installed watering station (not shown). While only one sensor 320 is shown, multiple sensors 320 may be employed, for instance to provide a more accurate indication of when the dog has approached the watering station.

Also shown in FIG. 3A is a removable cover element 322, which may be used as a name plate and battery cover. By way of example only, the cover element 322 may indicate the manufacturer of the watering station, or it may be personalized with the name of the dog. Disposed behind the removable cover element 322 is a battery box/receptacle 324, as shown in the side view of FIG. 3B. The battery box 324 preferably stores one or more batteries used to power the sensor 320 and/or other components described herein. This also helps to ensure access to fresh water in the case of a power failure, for instance in a home or apartment having a city water supply. The batteries are preferably replaceable, and may be rechargeable or single use type batteries.

Also shown in FIG. 3B is an incoming water supply line 326, which brings in potable water to the watering station. Along the water supply line 326 is an incoming water supply shutoff valve 328. The shutoff valve enables the incoming water supply to be turned off in case the system needs to be uninstalled for service or replacement. Water from the water supply line 326 is regulated by solenoid 330, which may also be powered by the battery in battery box 324. The solenoid 330 is desirably secured to a back surface of the receptacle area by a mounting bracket 332.

When the sensor(s) 320 indicates that the dog is approaching or has arrived at the watering station, the solenoid 330 is actuated to flow water from the incoming water supply line 326 through one or more water distribution hoses/lines 334. If multiple lines 334 are employed, a tee 336 may be used to split the water flow among the various lines 334. A pair of lines 334 is shown in FIG. 3C. The lines 334 lead to respective water outlets 338. Thus, fresh, potable water is supplied on demand without having to store the water in a reservoir or other receptacle.

As shown, the water outlets 338 may be positioned along an upper surface of bowl 304. However, the water outlets 338 may be placed in various other locations along the watering station. For instance, water outlets 338 may be located along the receptacle area 302 above the bowl 304. While two outlets 338 are shown, there may be a single outlet or more than two outlets. The number of outlets may be chosen based on the size of the dog. Furthermore, the outlets may be angled to ensure optimal consumption of the water by the dog. The outlets may be preconfigured prior to installation. Optionally, the outlets may be manually adjustable by the installer or pet owner.

Once installed and adjusted (if needed), the watering station provides fresh water without the owner having to replenish or change out the water as would otherwise be done with a conventional doggie bowl. This convenience may also give the owner piece of mind that his or her pets will have fresh water source even if the owner may be away or otherwise unavailable.

When the dog is finished drinking and leaves the area in front of the watering station, the sensor 320 provides this information to the solenoid valve 330, which shuts off water flow to the outlets 338. Any water not consumed by the dog will flow through drain 306a to outlet 306c and then to the wastewater plumbing, assuming no clog or debris. Thus, there will be substantially no standing water once the water flow is shut off. If for some reason there is a clog or other obstruction of drain 306a, some standing water may remain in the bowl element until the obstruction is removed. If enough water accumulates in the bowl element, excess water will be diverted through overflow 306b to outlet 306c. However, during normal operation without an obstruction, it should be apparent that effectively no dirty water is retained within bowl 304.

This promotes pet health by reducing the risk of germs breeding in dirty standing water. And having a fresh supply of potable water available whenever the animal is thirsty provides the added benefit of reducing the risk that the animal will drink from an unsafe source such as from the toilet.

Desirably, the exposed components of the watering station may be formed of corrosion resistant stainless steel, making the watering station easy to keep clean with soap and warm water and for many years of trouble free use. Other materials could be used, such as plastic or ceramic.

As noted above, FIGS. 4A-F illustrate a mounting bracket system which can be used, for instance, to provide a height adjustable watering station. The mounting bracket system may be used with any of the example watering stations discussed herein. FIGS. 4A-C illustrate an outer bracket element 400, and FIGS. 4D-F illustrate an inner bracket element 420. Outer bracket element 400 includes a first surface 402 and a second surface 404 preferably arranged perpendicular to one another to form an “L” shape. Similarly, inner bracket element includes a first surface 422 and a second surface 424 preferably arranged perpendicular to one another to form an “L” shape. One or more pairs of corresponding outer and inner bracket elements may be used to adjustably secure the watering station to a wall.

In one embodiment, the mounting bracket system is designed to pull the watering station snug to the face of the wall using angled tabs that mate with angled tabs on the unit itself. As shown, each bracket element 400 desirably includes at least two angled tabs 406 to enable the watering station to be set at different heights, accommodating multiple breed sizes. When arranged together, the outer and inner brackets form a U shape that will envelope the wall's edge. Set screws 428 or other fastener elements on the inner bracket element 420 are used to pinch the two bracket elements together tightly along the wall's edge.

In one arrangement, each inner bracket element includes slots 426 corresponding to the angled tabs 406 of a respective outer bracket element. The slots 426 have a size and are arranged at a complementary position to receive a given one of the angled tabs 406. For instance, if the tabs are ½″ wide and 1/16″ thick, the slots may be of a size slightly more than ½″ wide (e.g., 9/16″ wide or 2-10% wider than the tabs) and slightly more than 1/16″ thick (e.g., 5/64″ thick or 2-10% thicker than the tabs). The angle of each slot 426 also corresponds to the tab angle.

According to one example, the two-part brackets for the left and the right sides of the watering station will accommodate a range of wall thickness from ½″ -1½″. In one example, the outer brackets 400 are fixedly secured to or are integrally formed as part of the watering station.

Other mounting bracket configurations and systems may also be used with the watering stations described herein. For instance, the watering station may be surface mounted to a wall using fasteners, adhesive elements or the like.

Although the technology herein has been described with reference to particular embodiments, it is to be understood that these embodiments are merely illustrative of the principles and applications of the present technology. Modifications may be made to the illustrative embodiments and that other arrangements may be devised without departing from the spirit and scope of the present technology as defined by the appended claims.

1. A watering station for use by household pets and other animals, the watering station comprising:
a receptacle adapted to receive at least a portion of a head of an animal during drinking of potable water from the watering station;
a bowl element adjacent to the receptacle and configured to receive excess water not consumed by the animal;
a sensor configured to detect a presence of the animal;
an incoming water supply line adapted to provide potable water to the watering station;
a water supply regulator operatively coupled to the sensor and the incoming water supply line;
one or more water distribution lines coupled to the incoming water supply line, the one or more water distribution lines having corresponding outlets adjacent to either the receptacle or the bowl element; and
a drainage element disposed along a base region of the bowl element;
wherein the water supply regulator is configured to cause the incoming water supply line to dispense the potable water through the one or more water distribution lines in response to a signal from the sensor upon detection of the presence of the animal, and to cease dispensing the potable water upon cessation of the signal from the sensor; and
wherein the drainage element is configured to remove unconsumed water from the bowl element such that substantially no standing water remains in a bottom region of the bowl element when the water supply regulator has ceased dispensing the potable water.

2. The watering station of claim 1, wherein the drainage element includes a drain disposed along the bottom region of the bowl element and an outlet operatively coupled to the drain and configured for coupling to a wastewater pipe to evacuate the excess water from the watering station.

3. The watering station of claim 2, wherein the drainage element further includes an overflow receptacle disposed along a portion of the bowl element adjacent to the receptacle and operatively coupled to the outlet.

4. The watering station of claim 1, wherein the water supply regulator comprises a solenoid device.

5. The watering station of claim 1, further comprising a mounting bracket system configured to adjustably affix the watering station along a wall.

6. The watering station of claim 5, wherein the mounting bracket system includes at least two pairs of bracket elements, each pair having an outer bracket element and an inner bracket element.

7. The watering station of claim 6, wherein each outer bracket element includes two or more angled tabs arranged along a first wall of the outer bracket element.

8. The watering station of claim 7, wherein each inner bracket element includes slots corresponding to the two or more angled tabs of a respective outer bracket element, each slot having a size and being arranged at a complementary position to receive a given one of the angled tabs.

9. The watering station of claim 7, wherein corresponding ones of the outer and inner bracket elements form a U shape when arranged together, the U shape configured to envelope an edge of the wall to adjustably affix the watering station to the wall.

10. The watering station of claim 9, wherein one or more fastener elements of the inner bracket elements are used to pinch the outer and inner bracket elements together securely along the wall's edge.

11. The watering station of claim 5, wherein the mounting bracket system includes at least a pair of outer bracket elements configured to adjustably secure the watering station to stud members along the wall.

12. The watering station of claim 1, wherein the incoming water supply line and the drainage element each include flexible connections to enable height adjustment of the watering station along a wall.

13. The watering station of claim 1, further comprising a shut off valve operatively coupled to the incoming water supply line.

14. The watering station of claim 1, further comprising a power receptacle electrically coupled to the water supply regulator.

15. The watering station of claim 14, wherein the power receptacle comprises a battery box configured to store one or more batteries therein.

16. The watering station of claim 14, wherein the power receptacle includes an outer cover having a nameplate thereon.

17. The watering station of claim 1, wherein a height of the bowl element is adjustable to accommodate animals of different sizes.

18. A mounting bracket system for affixing an animal watering station to a wall structure, the mounting bracket system comprising:
at least two pairs of bracket elements, each pair having an outer bracket element and an inner bracket element;
each outer bracket element includes two or more angled tabs arranged along a first wall of the outer bracket element, the outer bracket elements being configured for adjustable placement along a surface of the animal watering station; and
each inner bracket element includes two or more receptacles each adapted to receive corresponding ones of the angled tabs of the outer bracket elements.

19. The mounting bracket system of claim 18, wherein each receptacle comprises a slot, the slot having a size and being arranged at a complementary position to receive a given one of the angled tabs.

20. The mounting bracket system of claim 18, wherein corresponding ones of the outer and inner bracket elements form a U shape when arranged together, the U shape configured to envelope an edge of the wall structure to adjustably affix the watering station to the wall structure.
